(19) United States
(12) Patent Application Publication
(10) Pub. No.: US 2018/0333793 A1
(43) Pub. Date: Nov. 22, 2018

(54) CIRCULAR TOOL FOR CUTTING MATERIAL

(71) Applicant: Julia Utensili S.P.A., Tarcento (IT)

(72) Inventors: Tristano CIANI, Tricesimo (IT); Michele PIRONTI, Padova (IT)

(21) Appl. No.: 15/777,488

(22) PCT Filed: Nov. 21, 2016
(86) PCT No.: PCT/IB2016/056998

§ 371 Date: May 18, 2018

(30) Foreign Application Priority Data
Nov. 20, 2015 (IT) 102015000075067

(51) Int. Cl. B23D 61/02; B23D 65/00

(52) U.S. Cl. CPC B23D 61/023; B23D 65/00; B23D 61/021; B23D 61/025

(57) ABSTRACT

A circular tool for cutting material includes a support disc (11) and a plurality of cutting inserts (10) attached on a circumferential periphery of the support disc (11).

### FIELD OF THE INVENTION

The present invention concerns a circular tool for cutting hard material, for example steel or suchlike.

The tool can be installed on a machine in which the reciprocal advance of the tool and the material to be cut is performed by the tool or the material to be cut.

### BACKGROUND OF THE INVENTION

In recent years, in all fields and in particular in the automotive field, the use of circular saws with ever-increasing thinness has become more and more requested; such saws reduce working offcuts due to the generation of chip.

In recent years, new steels have been developed, also called high resistance steels, which have extremely high mechanical properties of hardness and mechanical resistance, and which are used for making products such as tubes and section bars, subsequently used in various sectors. These types of material, with the same strength and safety, allow to reduce the resistant section and therefore the weight, compared with materials used up until a few years ago.

However, these materials are extremely hard and oblige producers of circular cutting tools to study tools with increasingly high performance and resistance to wear.

The increasingly limited thickness of the tube/section bar to be cut obliges producers to use circular cutting tools with an increasingly small pitch between the teeth (maximum 3 mm or 4 mm) so that during cutting at least two or three teeth are engaged. This allows to discharge the shearing forces on several surfaces and to prevent breakage of the cutting teeth.

It is known that circular tools for cutting hard material are provided with a plurality of cutting teeth with a suitably configured profile, that is, the part that performs the cutting action.

Furthermore, the cutting tooth is made of a material suitable to make a clean and precise cut, and to guarantee a certain number of cutting cycles.

Currently known tools that perform this type of work are preferably made entirely of a super rapid steel, or HSS, or sintered steel, and the cutting teeth are made directly on the cutting disc made in a single piece.

However, this type of integral tools made of sintered metal are very fragile and costly, due to the high cost of the material they are made of, and in some cases the investment is not worthwhile.

Alternatively, tools are known for cutting material in which a support disc is suitably shaped to define anchoring seatings on which plates of hard metal are applied, from which the cutting teeth are made. However, this solution does not allow to have a small enough pitch between the teeth, less than 4 mm, as required by current market requirements.

Solutions are also known, described in U.S. Pat. No. 535,722, DE-A-199,01,208, AU-B-526,322 and U.S. Pat. No. 2,022,433 in which the circular cutting tool is defined by a discoid support body on the periphery of which cutting inserts provided with a plurality of cutting teeth are attached, by mechanical attachment with screws, nails or rivets.

However, these solutions with mechanical attachment do not allow to satisfy the requirements described above, since it is not possible to make cutting tools with a limited thickness for example of less than 3 mm. Indeed, such limited thicknesses do not allow to have the space to attach a screw or a nail.

Furthermore, due to their conformation, at least some of these solutions do not allow to generate deep cuts in the metal material because they are constrained by the presence of thickening in the blade body toward the internal zone.

Another example of a circular cutting tool is described in document U.S. Pat. No. 6,298,762, which comprises a support disc and a plurality of cutting inserts made of carbide, brazed on the edge of the support disc and provided with a plurality of cutting teeth.

In particular, in this solution, the edge of the support disc has a circular shape and each cutting insert is provided with a connection edge, which is brazed to the edge of the support disc, and which is also shaped like the arc of a circle with a radius of curvature equal to that of the edge of the support disc.

In this solution all the stresses that occur during cutting are discharged directly onto the connection zone provided between the inserts and the support disc, that is, on the brazing.

However, when extremely hard materials are cut, the cutting stresses that occur very predictably cause the brazing to yield, making the whole circular tool completely useless.

Another disadvantage of this solution is that for each size of the support disc it is necessary to design and produce a predefined cutting insert with sizes suitable for the subsequent connection to the support disc.

Another disadvantage of this solution is the complexity of making the connection between the cutting inserts and the support disc. In fact, the elasticity modulus of the steel that the support disc is made of is very different from that of the hard metal that the cutting inserts are made of. When the welding is done, a high portion of the support disc is heated, and the subsequent cooling causes internal tensions due to the different coefficient of dilation of the two materials.

One purpose of the present invention is to obtain a low-cost tool able to cut materials, suitable for cutting pieces of any size, in particular with small sizes and limited thickness.

Another purpose of the present invention is to obtain a tool that can be re-sharpened several times.

Another purpose of the present invention is to obtain a cutting tooth with a pitch suitable for specific requirements.

Another purpose is to obtain a cutting tool of a material that has limited production costs.

Another purpose of the present invention is to obtain a cutting tool in which it is possible to intervene replacing portions of cutting tool that are broken or excessively worn.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, the present invention concerns a circular tool for cutting material comprising a support disc and a plurality of cutting inserts attached peripherally on the support disc.

According to one aspect of the present invention, the cutting inserts are provided with a plurality of cutting teeth.

In one insert, or in one or more inserts, the cutting teeth can be differentiated.

Moreover, the cutting teeth have a variable pitch, adaptable to needs.

The cutting inserts are integrated with the support disc in order to cover all the circumference.

The support disc is provided peripherally with a plurality of anchoring seatings to contrast the shearing force, with which the cutting inserts cooperate.

The cutting insert has at least one abutment portion cooperating with the anchoring seatings of the support disc and which advantageously allows, when the tool is being used, to absorb the shearing force with the piece to be worked.

According to one aspect of the present invention, the cutting inserts are attached continuously on the circumferential periphery of the support disc by means of at least either brazing, welding or gluing.

In particular, between the cutting inserts and the support disc a layer of brazing, a welding bead or a layer of gluing are respectively defined.

According to some embodiments, the cutting inserts are made, for example, of sintered material with particles of tungsten carbide, titanium, or tantalum, or other similar or comparable materials.

In a variant embodiment the cutting insert can already be made in its finished form, without needing other workings.

In another variant embodiment the cutting insert can be obtained by means of a mechanically worked plate.

Advantageously, it is possible to achieve standard semi-worked cutting inserts adaptable to different diameters of the support disc on which they are attached and subsequently finished.

With the present invention it is possible to obtain at least the following advantages:
higher performance of the tool;
possibility of repeated re-sharpening of the tool;
improved quality of the cuts obtained;
possibility of obtaining the same cutting times as traditional blades, but with reduced cutting speeds and greater durability of the tool, or vice versa the same durability and reduced cutting times;
possibility of cutting very thin pieces;
possibility of cutting very thin and resistant pieces (merely by way of example resistance to traction greater than 600-1200N/mm2).

Embodiments of the present invention also concern a method to make a circular tool for cutting material that provides to attach a plurality of cutting inserts on the circumferential periphery of a support disc.

According to one aspect of the present invention, the method provides to make a plurality of cutting teeth and an abutment portion in each of the cutting inserts and to make a plurality of anchoring seatings mating with the abutment portion in the support disc.

During the attachment of the cutting inserts on the support disc, the method provides to make the abutment portion and the anchoring seating cooperate with each other, and to attach the cutting inserts continuously on the circumferential periphery of the support disc by means of at least either brazing, welding or gluing.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a front view of a circular tool for cutting material in one embodiment;

FIG. 2 is a front view of a cutting insert and a view of its cross section;

FIG. 3 is a view in detail of the circular tool for cutting material;

FIG. 4 is a view of a possible variant of FIG. 3.

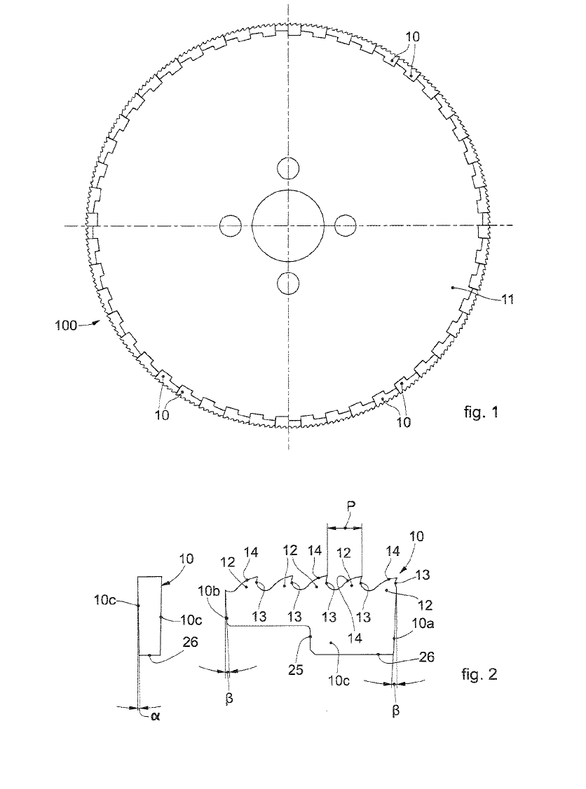

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

In accordance with the present description and with reference to the attached drawings, the invention concerns a circular tool 100 for cutting metal material that can be, for example, low alloy steel or high alloy steel, titanium, aluminum or similar.

Moreover the tool 100 is particularly indicated for cutting small pieces with a reduced thickness.

For example, the tool 100 can cut, individually or also in cooperation with other tools 100, solid bars with a diameter between 5 mm and 120 mm, tubes with sizes less than 5 mm and more than 600 mm and a thickness between 0.4 mm and 25 mm, or parallelepiped-shaped pieces obtained by shaping round tubes. Moreover, the tool 100 can be suitable for use in special machines, for example orbital machines, in which the same tool 100 is made to rotate around the piece in order to cut pieces of larger sizes.

The tool 100 comprises a support disc 11 and a plurality of cutting inserts 10 attached on the circumferential periphery of the support disc 11.

The support disc 11 can be made of metal material, for example steel, and can have a hardness comprised between 40HRC and 60HRC.

The cutting inserts 10 are attached continuously on the circumferential periphery of the support disc 11 by means of brazing, welding or gluing.

According to one embodiment of the present invention, the cutting inserts 10 are attached to the support disc 11 by means of brazing. The use of this connection technique allows to not alter the mechanical properties of the support disc 11 and of the cutting inserts 10, at the same time guaranteeing an increased capacity of resistance to the cutting stresses to which it is subjected.

According to one aspect of the present invention, the support disc 11 is provided on its circumferential periphery with a plurality of anchoring seatings 16 configured to allow the attachment of the cutting inserts 10.

In particular, it is provided that the support disc 11 is provided with an external circumferential edge 20 in which said anchoring seatings 16 are made toward the inside of the support disc 11.

According to one aspect of the present invention, the circumferential edge 20 defines a peripheral circumference 21 with a maximum external diameter De that defines the maximum sizes of the support disc 11.

The anchoring seatings 16 are made inside the peripheral circumference 21.

According to another solution, the anchoring seatings 16 are all the same size and are equally distributed along the circumferential edge.

According to a possible solution, the anchoring seatings 16 are defined by at least a support wall 22 and a striker wall 23. The support wall 22 and the striker wall 23 define with respect to each other a suitable concavity to house at least a part of the cutting insert 10.

In particular, it can be provided that both the support wall 22 and the striker wall 23 are substantially flat and disposed reciprocally angled with respect to each other. The flat development of the support wall 22 and the striker wall 23, rather than an arched development for example, allows to make the anchoring seatings 16 always the same size even in the case of a support disc 11 of a greater or lesser diameter than that of a disc considered.

In this way, at least for a determinate range of sizes of support discs, the latter are all provided with anchoring seatings 16 equal to each other and in which cutting inserts all of the same conformation and size can be anchored, and therefore are not variable as a function of the diameter of the support disc. This allows to considerably simplify the production of the cutting tools 100 as well as the management and production of the cutting inserts 10.

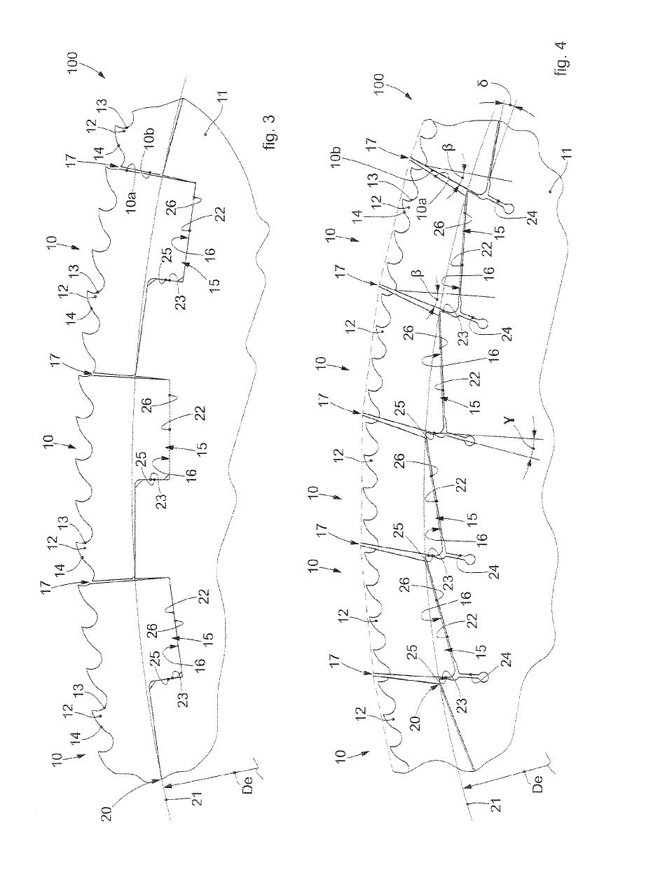

According to a possible solution of the present invention, shown for example in FIG. 3, the striker wall 23 extends radially with respect to the peripheral circumference 21.

According to a possible variant embodiment, the striker wall 23 extends angled with respect to the radial direction by a first angle γ that is comprised between 0° and 30°, preferably between 5° and 28°.

According to one solution of the present invention, the support wall 22 extends in a substantially circumferential direction.

According to a possible solution, the support wall 22 extends inclined with respect to the circumferential direction, by a second angle δ that, merely by way of example, is comprised between 0° and 10°, preferably between 0° and 5°.

According to a possible variant embodiment, at least one notch 24 can be made in the anchoring seating 16, which extends from the anchoring seating 16 toward the inside of the support disc 11 in order to allow, during use, the thermal dilation of the latter.

In particular the notches 24 made on the support disc 11 reduce or cancel out the tensions generated between the two materials during brazing or welding, and in the subsequent cooling, and reduce the possibility of flickering of the support disc 11 during cutting, if the support disc 11 overheats.

The notch 24 can end with a broadening in size, for example a circular shape, to reduce the concentration of tensions.

According to a possible solution, the notch 24 can be made in the intersection zone between the support wall 22 and the striker wall 23.

According to the variant shown in FIG. 3, the anchoring seating 16 has a substantially rectangular shape that extends toward the inside of the support disc. According to the variant embodiment shown in FIG. 4, the anchoring seating 16 has a substantially triangular shape.

The support disc 11 can be obtained by grinding, to define a thickness smaller than the at least initial thickness of the cutting inserts 10. The grinding operation allows to obtain a support disc 11 that is particularly balanced dynamically.

According to a possible solution, the support disc 11 and the cutting inserts 10 have a thickness comprised between 1 mm and 5 mm, preferably between 1.5 mm and 4 mm. This reduced thickness allows to obtain a cutting tool 100 able to generate a reduced mass of chip, and therefore any waste of material due to cutting.

The cutting insert 10, merely by way of example, has a length comprised between 12 mm and 24 mm, preferably between 14 mm and 22 m, and a height comprised between 6 mm and 12 mm, preferably between 6 mm and 10 mm. The reduced sizes of the cutting insert 10 allow to weld/braze it to the support disc 11 heating the latter much less compared with traditional solutions and therefore drastically reducing the deformations and tensions.

Moreover, the limited sizes of the cutting inserts 10 allow them to be used for all the diameters of the cutting tools 100 desired, also in view of the particular configuration, described hereafter, of the support disc 11.

The cutting insert 10 has at least one abutment portion 15 which advantageously allows to absorb the shearing force generated during cutting. Furthermore, the abutment portion 15 ensures a correct positioning of the cutting insert 10 with respect to the support disc 11, for example for the subsequent brazing operations.

In particular, the abutment portion 15 is positioned and anchored in the anchoring seating 16 by brazing, welding or gluing.

According to a possible solution of the present invention, the abutment portion 15 is provided with at least an abutment wall 25 that is positioned during use in abutment against the striker wall 23 of the anchoring seating 16, and a connection wall 26 positioned resting on and attached to the support wall 22 of the anchoring seating 16.

The abutment wall 25 and the connection wall 26 are disposed transverse to each other and can be flat.

According to a possible solution, the abutment portion 15 has a shape substantially mating with that of the anchoring seating 16, for example rectangular in the solution shown in FIG. 3, or triangular in the embodiment shown in FIG. 4.

In particular, it can be provided that the abutment portion 15 has a shape and size mating with those of the cavity defined between the support wall 22 and the striker wall 23 of the anchoring seating 16.

The cutting inserts 10 are provided with a plurality of cutting profiles or cutting teeth 12, made directly on the cutting inserts 10 and which can be configured according to requirements.

The cutting inserts 10 have a height, determined for example in a radial direction of the support disc 11, which is comprised between 6 mm and 15 mm, preferably between 8 mm and 12 mm. The height of the cutting inserts 10 allows to re-sharpen the cutting tool 100 about 4-8 times.

The cutting insert 10 is advantageously made of sintered materials, for example Widia®, comprising particles of tungsten carbide, titanium or tantalum or suchlike, or cemented carbide or HSS, or a ceramic material, or any material able to cut the piece and resist the mechanical forces in play.

The cutting insert 10 can have a hardness comprised between 75HRA and 95HRA.

In a variant embodiment, the cutting insert 10 can be made immediately in its finished form and attached already in its finished form to the support disc 11.

In another variant embodiment, the cutting insert 10 can be obtained from a plate of sintered material that is subsequently worked to obtain cutting teeth, for example.

Merely by way of example, it can be provided that the plate of sintered material is provided with the abutment portion 15 and is attached to the support disc 11 before making the cutting teeth 12 in it. With reference to FIG. 4, the plate of sintered material is schematized with lines of dashes.

The cutting teeth 12 in a finished cutting tool 100 can all be the same, or the cutting teeth 12 can be different. Advantageously, it is possible to make standard cutting inserts 10 adaptable to different support discs 11 with a diameter comprised between 200 mm and 600 mm.

According to the invention, the cutting teeth 12 are advantageously located one with respect to the other at a defined distance or pitch P.

The pitch P between the cutting teeth 12, in the cutting insert 10, is comprised between 2 mm and 8 mm, in particular between 3 mm and 7.5 mm, more particularly between 3.5 mm and 7 mm.

For example, the pitch P can be 3.7 mm, 4.6 mm or 6.1 mm.

The cutting tooth 12 (FIG. 2) has a cutting front 13 and a back 14.

During the cutting operation, each cutting tooth 12 acts on the piece in correspondence with its cutting front 13, removing the material.

With reference for example to FIG. 2, the cutting insert 10 has a substantially wedge-shaped cross section with a thickness that narrows from the cutting teeth 12 toward the inside.

The cutting insert 10 is also provided with a front wall 10a: the cutting fronts 13 of the cutting tooth 12 and a rear wall 10b, opposite the front wall 10a, face the front wall 10a.

The rear wall 10b can correspond with the abutment wall 25 as shown for example in FIG. 4, or can be separate from the abutment wall 25 as in the embodiment shown in FIG. 2.

Furthermore, the cutting insert 10 is provided with lateral walls 10c that extend convergent to each other to define the wedge-shaped cross section of the cutting insert 10.

In particular, each lateral wall 10c has an angle of inclination, or discharge angle α, which can be comprised between 0.3° and 1.5°, preferably between 0.5° and 1.0°.

Merely by way of example, the discharge angle a determines a difference between the maximum and minimum thickness of the cutting insert 10 which is comprised between 0.2 mm and 0.6 mm, preferably between 0.3 mm and 0.5 mm.

In particular, it is provided that the cutting insert 10 has its minimum thickness in correspondence with the connection zone with the anchoring seating 16, and that said thickness is equal to the thickness of the support disc 11.

The discharge angle α allows the cutting tool 100 to advance in its cutting motion, preventing the lateral walls 10c from sliding without adhering laterally to the walls of the piece being worked. This allows to cancel lateral pressures during cutting, the vibrations and resonance effects of the cutting tool 100, and this results in a very clean definitive cut.

In a variant embodiment, the discharge angle α can be made after the cutting insert 10 has been integrated with the support disc 11, for example by a brazing process.

In this way, the high temperatures of the attachment process are prevented from altering the sizes of the cutting insert 10. Therefore, the discharge angle α is made by a grinding process made directly on the support disc 11.

In another variant embodiment, the discharge angle α can be obtained before the cutting insert 10 has been integrated with the support disc 11.

Between adjacent pairs of cutting inserts 10, moreover, there is a gap 17 suitable to compensate for possible heat dilations of the cutting inserts 10 which occur when the tool is being used.

The gap 17 can have sizes comprised between about 0.2 mm and about 1.2 mm, preferably between 0.2 and 1 mm.

According to a possible solution it can be provided that the gap 17 has a bigger thickness at the base of the cutting inserts 10, and a smaller thickness toward the periphery. This solution facilitates operations to fill the gap 17 with the connection material, for example brazing material.

Furthermore, the gap has an angulation concordant with the cutting angle of the cutting teeth that is made by grinding the sectors.

In this way, even after sharpening, the gaps 17 maintain their relative positions with respect to the cutting teeth 12. It is also advantageous to provide that the gap 17 is made in front of the cutting edge and not behind it, so as not to weaken the support.

In a variant embodiment, the cutting insert 10 has a distancing angle β on the rear wall 10b and/or the front wall 10a between adjacent cutting inserts 10.

The distancing angle β is such as to define the gap 17 once the cutting insert 10 has been integrated with the support disc 11. According to the solution shown in FIGS. 2 and 3, the amplitude of the distancing angle β is comprised between 2° and 3.5°, in particular between 2.5° and 3°.

Advantageously, the amplitude of the distancing angle β is minimal, to prevent the material removed from the piece from snagging during cutting in correspondence with the gap 17.

According to a possible solution, shown for example in FIG. 4, the front wall 10a and/or the rear wall 10b have a distancing angle β comprised between 12° and 20°, preferably between 16° and 18°, determined with respect to an axis orthogonal to the connection wall 26.

The distancing angle can be determined as a function of the particular configuration of the tooth made and, during re-sharpening, allows to keep the resistant section of the final tooth of the sector constant.

The toothing is made in such a way that there is a defined number of teeth on each cutting insert 10, so that the total number of cutting teeth 12 is a multiple of the even number of cutting inserts 10. This means that the total number of cutting teeth 12 of the tool 100 is an even number, which is convenient for the sharpening operations.

It is clear that modifications and/or additions of parts may be made to the tool 100 for cutting material as described heretofore, without departing from the field and scope of the present invention.

It is also clear that, although the present invention has been described with reference to some specific examples, a person of skill in the art shall certainly be able to achieve many other equivalent forms of tool 100 for cutting material, having the characteristics as set forth in the claims and hence all coming within the field of protection defined thereby.

1.-15. (canceled)

16. A circular tool for cutting material, the tool comprising a support disc (11) and a plurality of cutting inserts (10) attached on a circumferential periphery of the support disc (11), wherein the support disc (11) has a plurality of anchoring seatings (16) and each cutting insert (10) of the plurality of cutting inserts (10) has a plurality of cutting teeth (12), and with at least one abutment portion (15) cooperating with at least one of the plurality of the anchoring seatings (16) of the support disc (11) and mating with the at least one of the plurality of anchoring seatings (16), and wherein the plurality of cutting inserts (10) are attached continuously on the circumferential periphery of the support disc (11) by at least one of brazing, welding or gluing.

17. The circular tool according to claim 16, wherein the support disc (11) has an external circumferential edge (20) in which the plurality of anchoring seatings (16) are made, toward an inside of the support disc (11), and wherein the plurality of anchoring seatings (16) are all the same size and are equally distributed along the circumferential edge (20).

18. The circular tool according to claim 16, wherein each anchoring seating (16) of the plurality of the anchoring seatings (16) is defined by at least one support wall (22) and by a striker wall (23), the at least one support wall (22) and the striker wall (23) defining a concavity with a shape and a size mating with a shape and a size of the at least one abutment portion (15).

19. The circular tool according to claim 18, wherein the at least one support wall (22) and the striker wall (23) are flat and reciprocally disposed angularly with respect to each other.

20. The circular tool according to claim 18, wherein the at least one abutment portion (15) has at least one abutment wall (25) positioned in abutment against the striker wall (23) of each of the anchoring seatings (16), and with a connection wall (26) positioned resting on and attached to the at least one support wall (22) of the each anchoring seating (16).

21. The circular tool according to claim 16, further comprising at least one notch (24) in each of the anchoring seatings (16) and extending from the each anchoring seating (16) toward the inside of the support disc (11).

22. The circular tool according to claim 21, wherein the at least one notch (24) is located in an intersection zone between the at least one support wall (22) and the striker wall (23).

23. The circular tool according to claim 16, wherein between an adjacent pair of the plurality of cutting inserts (10) is a gap (17) adapted to compensate for a heat dilation of the plurality of cutting inserts (10).

24. The circular tool according to claim 16, wherein the support disc (11) and the plurality of cutting inserts (10) have a thickness between 1 mm and 5 mm.

25. The circular tool according to claim 16, wherein the plurality of cutting inserts (10) has a brazed attachment to the support disc (11).

26. The circular tool according to claim 16, wherein the plurality of cutting teeth (12) have a pitch (P) between 2 mm and 8 mm.

27. The circular tool according to claim 16, wherein the support disc (11) has a hardness between 40HRC and 60HRC.

28. The circular tool according to claim 16, wherein the plurality of cutting inserts (10) have a hardness between 75HRA and 95HRA.

29. A method of making a circular tool for cutting material, the method comprising the steps of attaching a plurality of cutting inserts (10) on a circumferential periphery of a support disc (11), making a plurality of cutting teeth (12) and an abutment portion (15) in at least one of the plurality of cutting inserts (10), and mating an anchoring seating (16) with the abutment portion (15), the method further comprising, during the attaching of the at least one of the plurality of cutting inserts (10) on the circumferential periphery of the support disc (11), making the abutment portion (15) and the anchoring seating (16) cooperate with each other, and attaching the plurality of cutting inserts (10) continuously on the circumferential periphery of the support disc (11) by a step comprising one of brazing, welding and gluing.

30. The method according to claim 29, wherein the making of the plurality of cutting teeth (12) in the at least one of the plurality of cutting inserts (10) is carried out after the plurality of cutting inserts (10) have been attached on the support disc (11).
